(19) United States
(12) Patent Application Publication
(10) Pub. No.: US 2006/0226944 A1
(43) Pub. Date: Oct. 12, 2006

(54) Adjustable locking wedge system apparatus and method

(75) Inventor: Jordan M. Breindel, Mukwonago, WI (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Waukesha Electric Systems, Inc.

(21) Appl. No.: 11/092,699

(22) Filed: Mar. 30, 2005

(51) Int. Cl. H01F 27/06

(52) U.S. Cl. 336/65

(57) ABSTRACT

A pressurizing wedge assembly for a power transformer includes two mated wedges, each inscribed with locking transverse teeth and, in some embodiments, one of a pair of mating central alignment guides perpendicular to the teeth. The coil-side wedge has a cleat at the bottom to prevent it from slipping as the frame-side wedge is hammered into place. An alternative design uses three wedges, with two generally similar outer wedges and a center wedge with teeth and alignment guides on both sides. The wedges replace a system in which spreading pressure is applied alongside a gap into which a fixed block is inserted. The procedure of using hammers to drive the wedges can be replaced by a procedure in which power tools are employed.

### FIELD OF THE INVENTION

The present invention relates generally to power transformers. More particularly, the present invention relates to assembly of wiring structures within power transformers using nonconductive mechanical pressure fittings.

### BACKGROUND OF THE INVENTION

Very large electrical power distribution transformers, such as those used in facilities known as substations, use three-phase power at substantial voltages and currents, typically lowering the voltage drawn from long distance transmission lines and providing power to large customers—factories, apartment buildings, housing developments, and the like—which are in turn located in the vicinity of the substations. Comparable transformers are used at power plants and other facilities to step up voltage to levels suitable for application to long distance transmission lines. Once installed, if the load requirements of an installation remain largely unchanged, the transformers in a facility often can stand essentially untouched for decades, receiving little more attention than gas replenishment, visual and acoustical inspection, periodic functional testing, adjustments to the level and purity of the oil with which the transformers are filled, and cleaning of external surfaces to remove deposits that can promote arcing.

Such transformers are subject to electrical stresses such as short circuit loads, phase imbalances, and the like, and can experience strong mechanical stresses generated by such electrical events. Demonstrations have shown that transformers with inadequate internal structure can flex sufficiently to rupture under conditions of high load, while properly structured transformers can withstand comparable load conditions.

Establishing adequate internal structure in large transformers can require intensive labor and exacting craftsmanship. Methods and resources capable of simplifying and speeding the work of building—and of repairing—transformers with no sacrifice in reliability are potentially beneficial.

Accordingly, it is desirable to provide a method and apparatus that make more consistent and more rapid the application of uniform vertical stack force at locations distributed around the perimeter of transformer windings prior to the enclosing and oil filling of the transformers.

### SUMMARY OF THE INVENTION

The foregoing needs are met, to a great extent, by the present invention, wherein in one aspect an apparatus is provided that in some embodiments provides a locking wedge apparatus that can be positioned largely permanently at any perimeter location where needed in a transformer, and that can be tightened, preferably using usual tools of the art, to exert a level of force recognized in the art as appropriate for stable transformer performance under load.

In accordance with one embodiment of the present invention, a pressurizing wedge assembly for a transformer is presented. The pressurizing wedge assembly includes a coil-side wedge that bears against a transformer coil, and a frame-side wedge that bears against a transformer frame, wherein the frame-side wedge engages the coil-side wedge on respective engagement surfaces thereof, and wherein urging the coil-side and frame-side wedges with respect to one another in a direction to increase wedge assembly thickness applies pressure between the transformer frame and the transformer coil. In the wedge assembly, the engagement surface of the coil-side wedge and the engagement surface of the frame-side wedge interlock by respective pluralities of teeth, the respective teeth are configured to retain the wedges at a position with respect to one another absent application of sufficient urging force in the thickness increasing direction, and the respective teeth are configured to permit the wedges to slide with respect to one another in event of application of sufficient urging force in the thickness increasing direction.

In accordance with another embodiment of the present invention, a pressurizing wedge assembly for a transformer is presented. The pressurizing wedge assembly includes a first interlocking wedge element that bears against a transformer coil surface, a second interlocking wedge element that bears against a transformer frame surface proximal to and oriented generally parallel to the transformer coil surface, and a third wedge element interposed between and interlocking with both the first wedge element and the second wedge element, wherein urging the third wedge element between the first and second wedge elements in a direction to increase wedge assembly thickness applies pressure between the transformer frame and the transformer coil.

In accordance with yet another embodiment of the present invention, a pressurizing wedge assembly for a transformer is presented. The pressurizing wedge assembly includes means for applying normal force between an electrical winding and a frame surface proximal thereto along an axis generally perpendicular to the proximal frame surface within a transformer, means for measuring the normal force applied between the electrical winding and the proximal frame surface, means for incrementally altering a distance between the electrical winding and the proximal frame surface, and means for fixing the distance between the electrical winding and the proximal frame surface within a completed transformer, using the means for applying normal force, subsequent to altering the distance.

In accordance with still another embodiment of the present invention, a method for applying pressure between a transformer coil and a transformer frame is presented. The method for applying pressure includes placing in contact with a transformer coil a coil-side pressurizing wedge having a generally planar coil-facing surface and a generally planar engagement surface that diverge, wherein the coil-facing surface of the coil-side wedge rests against a frame-facing surface of the transformer coil, inserting between the coil-side wedge and a transformer frame a frame-side pressurizing wedge having a generally planar frame-facing surface and a generally planar engagement surface that diverge at approximately the same angle as the coil-facing surface and the engagement surface of the coil-side wedge, wherein the engagement surface of the frame-side wedge contacts the engagement surface of the coil-side wedge and the frame-facing surface of the frame-side wedge contacts a coil-facing surface of the transformer frame, and wherein the coil-facing surface of the coil-side wedge is generally parallel to the frame-facing surface of the frame-side wedge, and applying force to the frame-side wedge with respect to the coil-side wedge in a direction to cause the respective engagement surfaces of the coil-side wedge and the frame-side wedge to traverse in a thickness increasing direction, thereby applying force to the transformer coil with respect to the transformer frame.

In accordance with another embodiment of the present invention, a pressurizing wedge assembly for a transformer is presented. The pressurizing wedge assembly includes a first interlocking wedge element having a substantially planar first bearing surface, wherein the first bearing surface bears against a first surface of a first object external to the wedge assembly, wherein a second bearing surface of the first wedge element, distal to and oblique to the first bearing surface, has a plurality of locking ridges generally parallel to a line of intersection between a projection of a plane of the first bearing surface and a projection of a plane of the second bearing surface of the first wedge element, a second interlocking wedge element having a substantially planar first bearing surface, wherein the first bearing surface of the second interlocking wedge element bears against a first surface of a second object external to the wedge assembly, proximal to and oriented generally parallel to the first surface of the first object, wherein a second bearing surface of the second wedge element, distal to and oblique to the first bearing surface, has a plurality of locking ridges oriented generally parallel to a line of intersection between the projection of the plane of the first bearing surface and the projection of the plane of the second bearing surface of the second wedge element, wherein the second bearing surface of the first wedge element and the second bearing surface of the second wedge element lie in substantially parallel planes, wherein urging the first and second wedge elements with respect to one another in a direction to increase wedge assembly thickness applies pressure between the first object surface and the second object surface.

There have thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view of a transformer assembly.

FIG. 2 is a perspective view illustrating a pair of tightening wedges.

FIG. 3 is an enlarged view of the groove structure according to FIG. 2.

FIG. 4 is a perspective view of a three-part wedge system using separate alignment guide elements.

FIG. 5 is a perspective view of a pair of wedges with an alternative tooth embodiment.

FIG. 6 is a perspective view illustrating a pair of tightening wedges according to another embodiment of the invention.

FIG. 7 is a perspective view illustrating a three-part wedge system according to another embodiment of the invention.

### DETAILED DESCRIPTION

The invention will now be described with reference to the drawing figures, in which like reference numerals refer to like parts throughout. An embodiment in accordance with the present invention provides interlocking and self-aligning wedges configured to fill at least in part and to apply pressure within a void provided for the wedges between the top of a winding in a transformer and an upper structural element of the transformer. In some two-wedge embodiments, the lower wedge has an outboard, downward projecting cleat that allows it to bear against the windings and other materials below, inhibiting motion by the lower wedge toward the center of the transformer winding core. The upper wedge, lacking an outboard cleat, is free to slide toward the center of the transformer winding. The interlocking characteristic of the wedges is realized with generally transverse grooves, the size and shape of which afford a range of wedge heights and provide suitable fineness of adjustment. The self-aligning characteristic of the wedges is realized with an alignment structure. The structure can be a longitudinal tongue and groove or similar discrete structure, or can be an underlying shape in the interlocking faces of the wedges, on which shape the grooves are superimposed. By means of such a structure, the wedges are constrained to maintain axial alignment. The wedges are made from a material that is largely non-flexible, non-frangible, non-conductive, and non-ferromagnetic, and is compatible with permanent immersion in a range of liquids including petroleum distillates. Adjustment of the wedges is preferably performed using a mallet, a sledgehammer, or a comparable mass impact tool, or using a C-clamp, hydraulic press, or comparable compression tool.

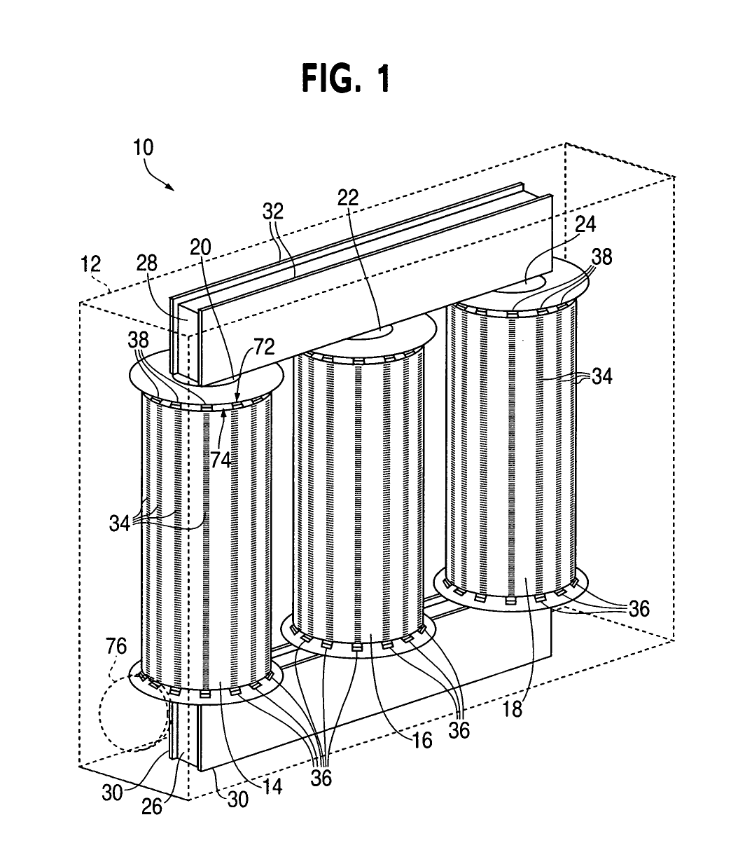

FIG. 1 is a perspective view illustrating an embodiment of the present inventive apparatus and method. A transformer 10, shown with a dashed element representing the approximate proportions of its outer housing 12, has three coils 14, 16, and 18 fitted over vertical core elements 20, 22, and 24, connected at bottom and top by core bridge assemblies 26 and 28, respectively. A bottom frame assembly 30 holds the bottom core bridge 26 and stabilizes the bases of the core elements 20, 22, and 24, while a top frame assembly 32 performs a like function at the top of the core elements 20, 22, and 24. Between the two frame assemblies are lines of individual spacer ribs 34, placed between each two turns of the coils 14, 16, and 18. Bottom spacer blocks 36 are fitted around the bottom between the coils 14, 16, and 18 and the bottom frame assembly 30; these spacer blocks 36 bear much of the weight of the coils 14, 16, and 18 plus any pressure applied to the coils 14, 16, and 18 by top spacers 38.

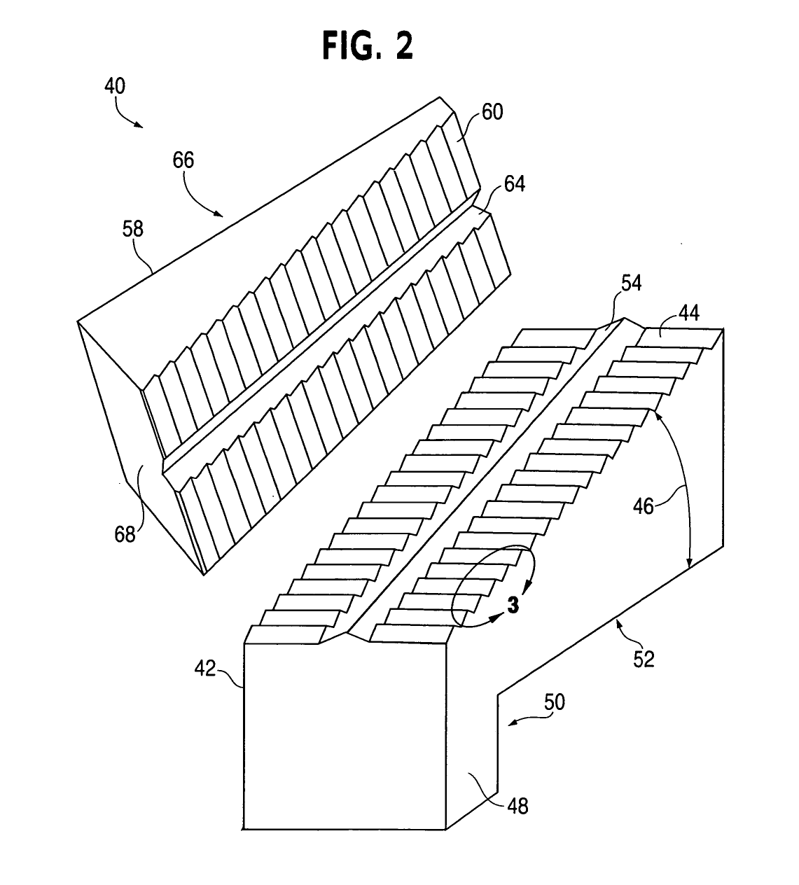

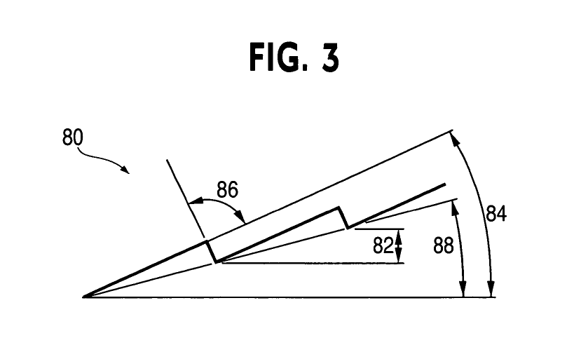

FIG. 2 is a perspective view showing a pair of wedges 40 according to a two-wedge embodiment of the inventive apparatus. The lower wedge 42 has a locking surface 44 with a mean taper angle 46, shown in more detail in FIG. 3, which taper is selected to provide a range of adjustment appropriate to the pressure range for a particular transformer configuration. The lower wedge 42 further has a cleat 48, the inmost face 50 of which is configured to bear against the vertical outside surface of the coils 14, 16, and 18 of FIG. 1 when installed. The lower wedge 42 also has a bottom surface 52 which is configured to bear against the generally horizontal top surface of the coils 14, 16, and 18 when installed. The lower wedge 42 has a central guide element 54 that can maintain alignment between the wedge pair 40 during installation and can maintain position stability over the life of the transformer 10. Another characteristic of the wedge pair 40 is stepped locking surfaces 44 and 60, respectively, likewise presented in greater detail in FIG. 3.

FIG. 2 further shows an upper wedge 58, oriented in the figure to show the upper wedge locking surface 60 that contacts the lower wedge locking surface 44. A mating guide element 64 joins with the guide element 54 of the lower wedge 42 to maintain alignment. The top surface 66 of the upper wedge 58 in the embodiment shown is a generally smooth surface, allowing the upper wedge 58 to move with respect to the top frame assembly 32 shown in FIG. 1. The striking surface 68 of the upper wedge 58 accepts force by available means, such as blows from a hammer coupled through a block of a material similar to that of the wedges 40, direct blows from a hammer or mallet, force applied using a compression band or a press, or other methods.

Returning to FIG. 1, it is to be understood that ordinary construction of a transformer 10 calls for use of rectangular top spacers 38 of a thickness determined by design and workmanship for a model or sample of a transformer 10, wherein the top spacers 38 are radially positioned substantially uniformly around the top of each coil 14, 16, and 18 to establish a default distance from the top of the coil 14, 16, and 18 to the surface of the top frame assembly 32.

As shown in FIG. 1, spacer ribs 34 are typically fitted between windings of the coils 14, 16, and 18 at various locations around the perimeter of the respective coils 14, 16, and 18. When the top frame assembly 32 is assembled into place, testing establishes whether the top spacers 38 each provide sufficient force. A typical criterion for successful assembly of a top frame assembly 32 and associated top spacers 38 is determination whether at least one of the spacer ribs 34 can be caused to shift laterally by striking the spacer rib 34. The striking test is typically performed, using a hammer of appropriate size, at an appropriate force level, with or without the use of a drift punch or like force transfer tool. Passing this test can be shown to correlate to the assembly procedure's having provided pressure in an acceptable range, so that final assembly will demonstrate that the transformer has been given correct internal structure.

Continuing in FIG. 1, it is possible that the force at a location 72 is not sufficient—that is, a spacer rib 34 shifts when struck as described, or the equivalent. Lacking the inventive apparatus, the top spacer 38 vertically aligned with the failed location 72 is removed, which may require temporarily inserting combinations of setup spacers to either side of the location of the removed top spacer 38, driving between the combinations of setup spacers one or more knifelike setup wedges to apply force to the affected coil 14 until the spacer 38 can be removed. Further pressure is then applied to the location 72, until the affected coil 14 is pressed downward and away from the top frame assembly 32 at the location 72 sufficiently to enlarge a gap 74. A replacement top spacer 38 somewhat thicker than the default top spacer 38, or an assembly combining a spacer 38 and one or more added shims, is inserted in the gap 74, after which the setup spacers and wedges are removed. This releases the setup pressure, and transfers the load to the oversized top spacer or assembly 38. The work thus completed is thereupon evaluated as to the achieved pressure level.

Should the test again fail, the sector is wedged open again, slightly wider than previously, and the top spacer 38 is replaced with a still thicker one, whereupon the setup wedge apparatus is removed and the test repeated for the failed spacer rib 34 and any others possibly affected by the adjustment.

The inventive apparatus and method provide an alternative to the above tightening process. Once a location of insufficient tightness is identified, the standard top spacer 38 is removed, by the above method if required, and a lower wedge 42 and an upper wedge 58 as shown in FIG. 2 are inserted. The wedges are fitted together at a convenient interlocking position, such as with the top face 66 of the upper wedge 58 roughly aligned with the upper extent of the lower wedge 42, or with the height of the pair 40 slightly less than the unpressed height of the gap 74 in FIG. 1. The assembled wedge pair 40 is thereupon inserted into the gap 74 until the cleat 48 on the lower wedge 42 rests against the coil 14, shown in FIG. 1. The upper wedge 58 is then urged inward toward the center of the coil 14, using, for example, a sledgehammer, until the previously loose spacer rib 34 in the coil 14 is immobilized as in the prior method. Unlike the prior method, however, the operation is now complete, with the wedge pair 40 to be left in place. If, during a final checkout, some spacer ribs 34 pressed by wedge pairs 40 are found to be insufficiently tight, application of further tightening on the affected wedge pairs 40 can be performed with further hammer blows, rather than by repeated disassembly and reassembly using thicker and thicker top spacers 38.

The inventive apparatus and method may be applied equally in production and as a repair procedure for transformers in the field. Should testing indicate that a transformer of comparable construction and of any age has insufficiently tight construction, the transformer in FIG. 1 can be drained of oil, at least in part, after which a manhole cover 76 can be removed, and a service person can enter the transformer housing 12 and perform the method at the location of the fault. Such a method may be significantly less onerous than the previous method, particularly since the iterative aspect of the previous method is significantly reduced. As noted above, a clamp device, such as a C-clamp having a screw thread, or a similarly-configured hydraulic ram, may be effective for reducing a mobility requirement inside the transformer housing 12, compared to using a sledgehammer.

FIG. 3 shows an auxiliary view of a portion of a stepped locking surface 80 of either of the wedges 40 as indicated in the callout in FIG. 2. The step size 82, step surface angle 84, and back slope angle 86, like the mean wedge taper angle 88, are determined by several criteria. The desired range of adjustment is a first such criterion, since a fully driven upper wedge 58, as shown in FIG. 2, should preferably be inserted inward at least far enough not to protrude beyond the housing 12 limits as shown in FIG. 1, and not to cause interference with a wedge pair 40, as shown in FIG. 2, on an adjacent coil surface if located near the proximal parts of two of the coils 14, 16, or 18 in a transformer 10, as shown in FIG. 1. The extent of compression is a related criterion. The total height and change in height of the coils 14, 16, and 18 between fully relaxed and fully compressed determines the taper length and height change as the wedge pair 40 of FIG. 2 are driven together. The step size 82 in FIG. 3 determines the increment of change in pressure for each increment of advance. The step surface angle 84 defines in part the force required for each advance, while affecting position retention.

Continuing in FIG. 3, the back slope angle 86 similarly affects position retention, along with ease of manufacturing and ruggedness of the wedges 40, as shown in FIG. 2. That is, if the back slope angle 86 is, for example, perpendicular to the step surface angle 84, manufacturing may be simplified, allowing the use of ordinary end mills in creating the wedges 40, for example. A back slope angle 86 of less than ninety degrees with respect to the step surface angle 84 may provide stronger locking, but may make the tips of the steps less durable. An optimum combination of angles for a specific application may be determined in consideration of the processes to be employed in making the wedges 40, such as milling versus molding, as well as properties such as toughness and injection molding flow properties of the materials used.

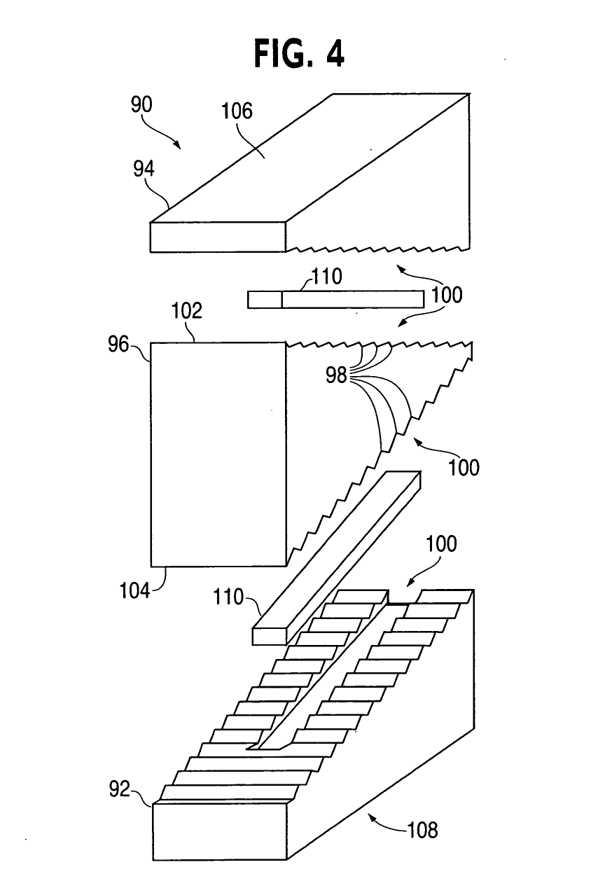

FIG. 4 shows a three-part wedge assembly 90 in which both the bottom wedge 92 and the top wedge 94 are substantially similar to the lower wedge 42 in FIG. 2, except omitting the cleat 48 in the embodiment shown, while the middle wedge 96 has steps 98 and guide provisions 100 on two opposed surfaces 102 and 104. Where the configuration of the top frame assembly 32 of FIG. 1 is compatible with using a cleat, adding cleats to the bottom and top wedges 92 and 94, respectively, as in the bottom wedge 42 in FIG. 2, may show advantage in some embodiments. Since, if equipped with cleats, neither of the wedge assembly surfaces 106 and 108 that contact other transformer components can move appreciably with respect to other transformer components during installation, all motion then takes place between elements of the three-part wedge assembly 90. All angles and other dimensions are likely to require analysis and validation, as determined by the required adjustment range, the materials used, and other criteria. Since individual step advances between both the bottom 92 and middle 96 and the top 94 and middle 96 wedges can occur largely simultaneously with a three-part wedge assembly 90, the rate of advance per step, and thus the required force, can roughly double. In some embodiments, a shallower slope may be preferred in order to permit lower applied force levels in proportion to the final pressure achieved.

The guides 110 in FIG. 4 are shown as separate components, so that the guide provision 100 resembles a keyway-and-key arrangement, with equivalent recesses in all three wedges 92, 94, and 96. This configuration may be advantageous in some embodiments.

Construction of wedges according to FIGS. 2 and 4 preferably includes a sufficient thickness of material to withstand the applied forces, such as to prevent overstress of the region of transition from wedge to cleat during installation. Maximum material thickness may be a function of cost and fabrication limitations for materials, such as available thickness limits for transformer-compatible materials to be machined, or limitations on molding thickness for materials to be injection molded. In some embodiments, wedges may be co-positioned with parallel-faced spacers to increase overall thickness.

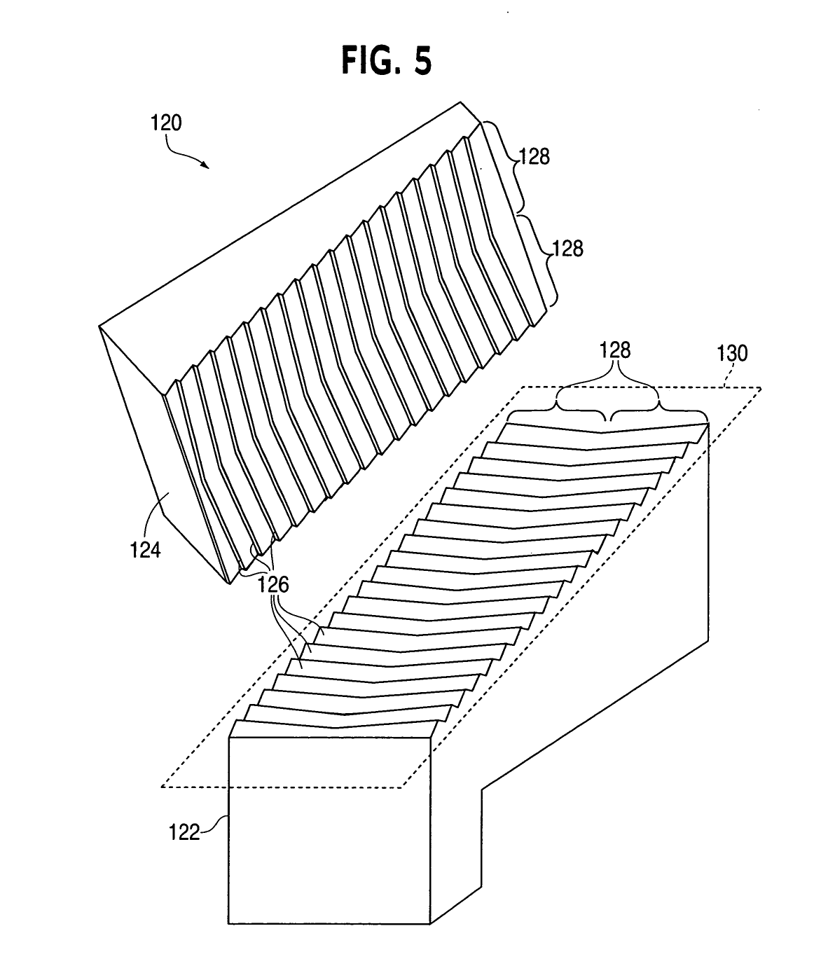

FIG. 5 is a perspective view of a pair of wedges 120 with an alternative tooth embodiment. It is to be understood that references to transverse teeth herein include configurations in which the tooth profile does not necessarily follow a straight line. In FIG. 5, for example, the lower and upper wedges 122 and 124, respectively, are shown to have teeth 126 formed in vees or chevron shapes of greater or lesser steepness; such teeth can be cut along an arcuate or other nonlinear path, rather than having two linear sections 128, if preferred. In the configuration shown, the wedges 122 and 124 are to at least some extent self-aligning without need for a separate alignment guide feature. The edges of the tooth sections 128 in the wedge pair 120 shown in FIG. 5 lie in a plane as indicated by the dashed surface 130.

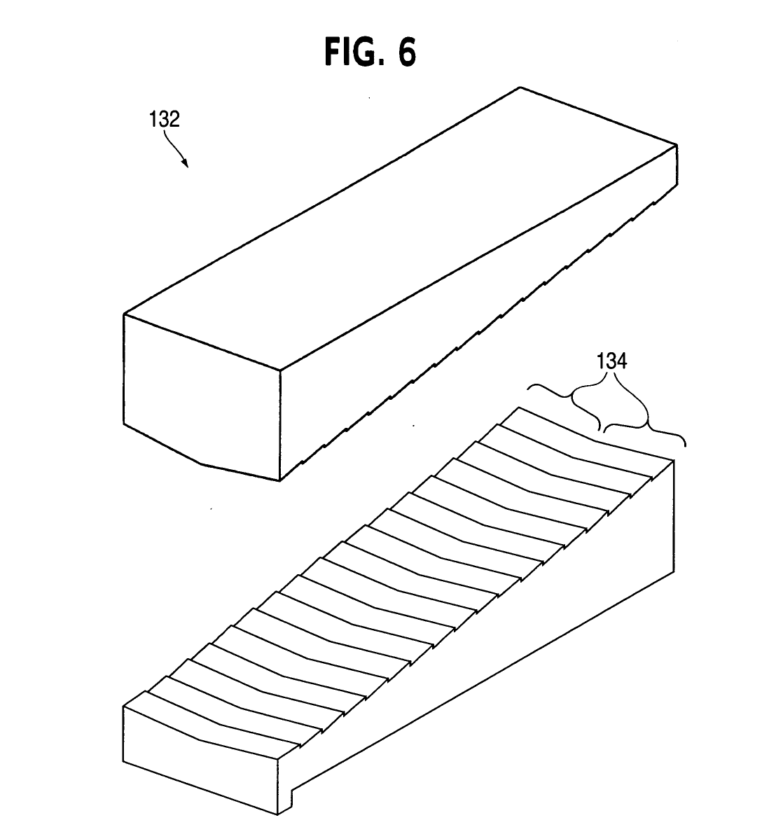

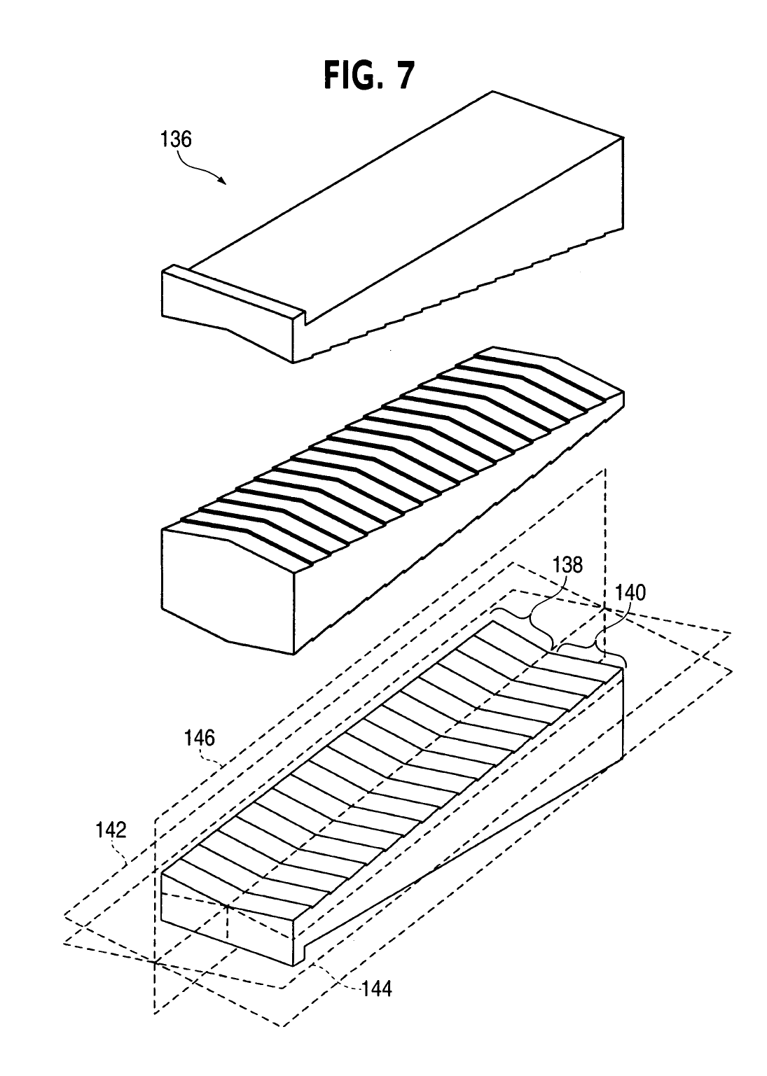

FIG. 6 is a perspective view of another pair of wedges 132 wherein the corresponding tooth sections 134 lie in two intersecting planes, also shown in FIG. 7.

FIG. 7 is a perspective view of a three-wedge system 136 wherein tooth sections 138 and 140 lie in intersecting planes 142 and 144, respectively. Intersecting planes 142 and 144 meet at a reference plane 146 through the midline of the assembled wedges 136. The effect of this arrangement is to provide self-centering without a separate guide feature, as in the embodiments of FIGS. 5 and 6.

Selection of materials for wedges according to the inventive apparatus includes several considerations. Temperature range for a transformer during manufacture may exceed 150 degrees Celsius, while operating temperatures may be higher still, so a selected material should preferably withstand such temperatures with known and acceptable changes in its physical properties. Additionally, within a transformer, physical dimensions of steel and copper components, as well as fill fluids, change with temperature, so applied stress can vary with temperature. Thus, the selected material should have a thermal coefficient of expansion that is compatible with those of other materials in the transformer.

Removal of moisture and other fluid contaminants from a transformer during construction or overhaul can include prolonged application of relatively hard vacuum at elevated temperature, so outgassing properties of a candidate wedge material should be known and should be compatible with the materials of the transformer. A typical transformer is filled, during sequential manufacturing and overhaul steps, with a succession and a variety of petroleum distillates. These distillates can leave residues and can be subjected to breakdown during transformer operation, so the wedge material should also be chosen for compatibility with all of the manufacturing, operational, and breakdown products to be found in the transformer.

Mechanical forces during assembly include final loads in some embodiments that can be on the order of 50 Kg/cm². The wedge material thus requires sufficient hardness to withstand this considerable static loading, with a multiplier for impacts applied during assembly, for loads due to thermal changes, and for structural safety margins. In addition, the environment within a transformer includes strong electromagnetic forces, with varying magnetic fields as well as electrical currents present. Thus, the wedge material should preferably have low conductivity and satisfactory dielectric and dissipation constants, as well as being substantially free of ferromagnetic properties, including contaminants and effects of aging in the environment described.

Although an example of the wedge is shown in which a first wedge element has a cleat that bears against coil windings, and a second wedge element is driven radially inward using a hammer or similar tool, it will be appreciated that numerous cleatless configurations can be used, and that in any configuration, force can be applied using a hand or power operated tool such as a screw clamp or a hydraulic press with opposing jaws to draw the wedges together without bearing on the coils. Further, while the tightening motion described is radial and directed inward within each coil in a transformer, circumferential tightening motion is possible with both the two-part and three-part wedge embodiments, where the wedges are oriented circumferentially rather than radially.

While evaluation of force levels is described using a hammer to attempt to cause a shift in the position of a spacer, an embedded strain gauge within a suitably designed spacer, or another comparable measuring device, can be provided, to directly or indirectly detect the force applied by the wedges. Also, although the wedges are useful to assemble power transformers for the electrical power distribution industry, they can also be used for a variety of other controlled pressure applications in which it is preferable to include an adjustable element that is sufficiently stable mechanically, thermally, electromagnetically, and chemically, as well as sufficiently low in cost, to permit the element to be left in place.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to that fall within the scope of the invention.

What is claimed is:

1. A pressurizing wedge assembly for a transformer, comprising:
a coil-side wedge that bears against a transformer coil; and
a frame-side wedge that bears against a transformer frame, wherein the frame-side wedge engages the coil-side wedge on respective engagement surfaces thereof, and wherein urging the coil-side and frame-side wedges with respect to one another in a direction to increase wedge assembly thickness applies pressure between the transformer frame and the transformer coil.

2. The wedge assembly of claim 1, wherein the engagement surface of the coil-side wedge and the engagement surface of the frame-side wedge interlock by respective pluralities of teeth, wherein the respective teeth are configured to retain the wedges at a position with respect to one another absent application of sufficient urging force in the thickness increasing direction, and wherein the respective teeth are configured to permit the wedges to slide with respect to one another in event of application of sufficient urging force in the thickness increasing direction.

3. The wedge assembly of claim 2, wherein the coil-side wedge has a coil-side wedge body comprising:
a generally planar coil-side wedge body surface; and
a generally planar coil-side engagement surface diverging therefrom, whereupon each coil-side tooth in the plurality of coil-side teeth extends substantially across the coil-side engagement surface, wherein a maximum extent of each coil-side tooth away from the coil-side wedge body surface forms a substantially continuous edge, substantially parallel to the coil-side wedge body surface, and generally transverse to the thickness increasing direction.

4. The wedge assembly of claim 3, wherein the coil-side wedge body further comprises:
two generally symmetrical sidewalls, wherein a projection of the plane of the coil-side wedge body surface and a projection of the plane of the coil-side engagement surface intersect in a line generally perpendicular to a plane equidistant from the sidewalls.

5. The wedge assembly of claim 4, wherein the coil-side wedge body further comprises a cleat, wherein the cleat further comprises:
a cleat body projecting generally away from the coil-side surface; and
a cleat-to-coil contact surface on the cleat body generally perpendicular to the coil-side surface of the coil-side wedge body, wherein a plane of the cleat-to-coil contact surface is generally parallel to the line of intersection of the coil-side surface and the engagement surface of the coil-side wedge.

6. The wedge assembly of claim 5, wherein each coil-side tooth further comprises:
a substantially planar front coil-side tooth surface, wherein a projection of the front coil-side tooth surface intersects the plane of the coil-side wedge body surface in a line generally parallel to the line of intersection of the coil-side wedge body surface and the coil-side engagement surface, and wherein the line of intersection of the front coil-side tooth surface and the coil-side wedge body surface falls between a perpendicular projection of a line comprising a distal extent of the front coil-side tooth surface onto the coil-side wedge body surface and the line of intersection of the coil-side wedge body surface and the coil-side engagement surface; and
a substantially planar back coil-side tooth surface, wherein a projection of the back coil-side tooth surface intersects the plane of the coil-side wedge body surface in a line generally parallel to the line of intersection of the coil-side wedge body surface and the coil-side engagement surface, and wherein the line of intersection of the back coil-side tooth surface and the coil-side surface falls further from the intersection of the coil-side wedge body surface and the coil-side engagement surface than does the projection of the front coil-side tooth surface.

7. The wedge assembly of claim 3, wherein the coil-side wedge further comprises an alignment guide oriented substantially in the thickness increasing direction.

8. The wedge assembly of claim 7, wherein the alignment guide is one of a raised oblong of generally uniform profile and a recessed oblong of generally uniform profile, and wherein the alignment guide extends for at least a part of the length of the coil-side wedge engagement surface.

9. The wedge assembly of claim 2, wherein the frame-side wedge has a frame-side wedge body comprising:
a generally planar frame-side surface; and
a generally planar frame-side engagement surface diverging therefrom, whereupon each frame-side tooth in the plurality of frame-side teeth extends substantially across the frame-side engagement surface, wherein a maximum extent of each frame-side tooth away from the frame-side surface forms a substantially continuous edge, substantially parallel to the frame-side surface, and generally transverse to the thickness increasing direction.

10. The wedge assembly of claim 9, wherein the frame-side wedge body further comprises:
two generally symmetrical sidewalls, wherein a projection of the plane of the frame-side surface and a projection of the plane of the engagement surface meet in a line generally perpendicular to a plane equidistant from the sidewalls.

11. The wedge assembly of claim 9, wherein each frame-side tooth further comprises:
a substantially planar front frame-side tooth surface, wherein a planar projection of the front frame-side tooth surface intersects the plane of the frame-side wedge body surface in a line generally parallel to the line of intersection of the frame-side wedge body surface and the frame-side engagement surface, and wherein the line of intersection of the front frame-side tooth surface and the frame-side wedge body surface falls between a perpendicular projection of a line comprising a distal extent of the front frame-side tooth surface to the frame-side wedge body surface and the intersection of the frame-side wedge body surface and the frame-side engagement surface; and
a substantially planar back frame-side tooth surface, wherein a projection of the back frame-side tooth surface intersects the plane of the frame-side wedge body surface in a line generally parallel to the line of intersection of the frame-side wedge body surface and the frame-side engagement surface, and wherein the line of intersection of the back frame-side tooth surface and the frame-side wedge body surface falls further from the intersection of the frame-side wedge body surface and the frame-side engagement surface than does the projection of the front frame-side tooth surface.

12. The wedge assembly of claim 7, wherein the frame-side wedge further comprises an alignment guide oriented substantially in the thickness increasing direction.

13. The wedge assembly of claim 12, wherein the alignment guide is one of a recessed oblong of generally uniform profile and a raised oblong of generally uniform profile, and wherein the alignment guide extends for at least a part of the length of the frame-side wedge engagement surface.

14. The wedge assembly of claim 2, wherein the wedges of the assembly further comprise at least one of being substantially nonconductive, being substantially free of ferromagnetic character, being substantially chemically nonreactive to petroleum distillates, and being substantially free of outgassing.

15. The wedge assembly of claim 3, further comprising an alignment guide, wherein the alignment guide is an oblong fitting of generally uniform profile fitted at least in part into and free to slide within a recess in the engagement surfaces of each of the of the coil-side and frame-side wedges.

16. The wedge assembly of claim 2, wherein the wedges are made from a material selected from a list consisting essentially of linen phenolic, Nylon®, polyetheretherketone, polyphenylene sulfide, and other engineering plastics, including engineering plastics containing additives such as glass fibers and carbon fibers.

17. The wedge assembly of claim 2, wherein the respective pluralities of teeth have a common chevron shape that is bilaterally symmetrical about a plane of symmetry, and wherein a line of intersection of a front tooth surface and a back tooth surface of a first side of the chevron shape for a coil side tooth and a corresponding line of intersection of a front tooth surface and a back tooth surface of a second side of the chevron shape for a coil-side tooth lie in a common plane perpendicular to the plane of symmetry.

18. The wedge assembly of claim 2, wherein the respective pluralities of teeth have a common chevron shape that is bilaterally symmetrical about a plane of symmetry, and wherein a line of intersection of a front tooth surface and a back tooth surface of a first side of the chevron shape for a coil side tooth lie in a first plane not perpendicular to the plane of symmetry, and wherein a corresponding line of intersection of a front tooth surface and a back tooth surface of a second side of the chevron shape for a coil-side tooth lie in a second plane symmetric about the plane of symmetry with respect to the first plane.

19. A pressurizing wedge assembly for a transformer, comprising:
a first interlocking wedge element that bears against a transformer coil surface;
a second interlocking wedge element that bears against a transformer frame surface proximal to and oriented generally parallel to the transformer coil surface; and
a third wedge element interposed between and interlocking with both the first wedge element and the second wedge element, wherein urging the third wedge element between the first and second wedge elements in a direction to increase wedge assembly thickness applies pressure between the transformer frame and the transformer coil.

20. The wedge assembly of claim 19, further comprising a plurality of alignment guides, wherein each alignment guide of the plurality is one of an oblong fitting of generally uniform profile fitted at least in part into and free to slide within a recess in the interlocking surfaces of two wedges, an oblong fitting integral with a wedge, and an oblong recess within a wedge, and wherein each pair of interlocking wedge surfaces is aligned with respect to each other using an alignment guide.

21. A pressurizing wedge assembly for a transformer, comprising:
means for applying a normal force between an electrical winding and a frame surface proximal thereto along an axis generally perpendicular to the proximal frame surface within a transformer;
means for measuring the normal force applied between the electrical winding and the proximal frame surface;
means for incrementally altering a distance between the electrical winding and the proximal frame surface; and
means for fixing the distance between the electrical winding and the proximal frame surface within a completed transformer, using the means for applying normal force, subsequent to altering the distance.

22. The wedge assembly of claim 21, wherein the means for applying normal force comprises application of a compressive force substantially transversely to the direction of normal force applied between the electrical winding and the proximal frame surface, wherein the compressive force is applied between a pair of wedges having a first contacting face of a first wedge of the pair contacting a second contacting face of a second wedge of the pair, wherein the wedges of the pair are configured to increase the normal force as the compressive force is applied.

23. The wedge assembly of claim 22, wherein the means for fixing the distance between the electrical winding and the proximal frame surface further comprises a first plurality of transverse interlocking elements integral with the first contacting face and a second plurality of transverse interlocking elements integral with the second contacting face, wherein the interlocking of the interlocking elements maintains the normal force between the electrical winding and the proximal frame surface.

24. The wedge assembly of claim 21, further comprising means for maintaining alignment between the first wedge and the second wedge, wherein a groove in the first one of the wedges and a raised ridge in the second one of the wedges limit motion to an aligned direction.

25. A method for applying pressure between a transformer coil and a transformer frame, comprising:
placing in contact with a transformer coil a coil-side pressurizing wedge having a generally planar coil-facing surface and a generally planar engagement surface that diverge, wherein the coil-facing surface of the coil-side wedge rests against a frame-facing surface of the transformer coil;
inserting between the coil-side wedge and a transformer frame a frame-side pressurizing wedge having a generally planar frame-facing surface and a generally planar engagement surface that diverge at approximately the same angle as the coil-facing surface and the engagement surface of the coil-side wedge, wherein the engagement surface of the frame-side wedge contacts the engagement surface of the coil-side wedge and the frame-facing surface of the frame-side wedge contacts a coil-facing surface of the transformer frame, and wherein the coil-facing surface of the coil-side wedge is generally parallel to the frame-facing surface of the frame-side wedge; and
applying force to the frame-side wedge with respect to the coil-side wedge in a direction to cause the respective engagement surfaces of the coil-side wedge and the frame-side wedge to traverse in a thickness increasing direction, thereby applying force to the transformer coil with respect to the transformer frame.

26. The method for applying pressure of claim 25, further comprising:
establishing a cleat on the coil-facing surface of the coil-side pressurizing wedge, thereby allowing the coil-side wedge to bear against the transformer coil without thereafter substantially moving with respect thereto.

27. The method for applying pressure of claim 26, further comprising:
providing a plurality of parallel, generally transverse ridges on the respective engagement surfaces of the coil-side and frame-side pressurizing wedges, configured to interlock the wedges, whereby application of a sufficient increment of force to the wedges causes the engagement surfaces to advance to a next interlocking position, thereby increasing the thickness of the wedge pair.

28. The method for applying pressure of claim 27, further comprising:
configuring a tongue and groove guide for the respective wedges, parallel to the direction of motion that increases the thickness of the wedge pair, whereby alignment of the respective transverse ridges of the pressurizing wedges is maintained.

29. The method for applying pressure of claim 27, further comprising:
configuring a guide in the respective wedges comprising aligning longitudinal grooves in each of the wedges, directed parallel to the direction of motion that increases the thickness of the wedge pair, and a separate inserted element fitted to the grooves in both wedges, whereby alignment between the transverse ridges of the pressurizing wedges is maintained.

30. A pressurizing wedge assembly, comprising:
a first interlocking wedge element having a substantially planar first bearing surface, wherein the first bearing surface bears against a first surface of a first object external to the wedge assembly, wherein a second bearing surface of the first wedge element, distal to and oblique to the first bearing surface, has a plurality of locking ridges generally parallel to a line of intersection between a projection of a plane of the first bearing surface and a projection of a plane of the second bearing surface of the first wedge element; and
a second interlocking wedge element having a substantially planar first bearing surface, wherein the first bearing surface of the second interlocking wedge element bears against a first surface of a second object external to the wedge assembly, proximal to and oriented generally parallel to the first surface of the first object, wherein a second bearing surface of the second wedge element, distal to and oblique to the first bearing surface, has a plurality of locking ridges oriented generally parallel to a line of intersection between the projection of the plane of the first bearing surface and the projection of the plane of the second bearing surface of the second wedge element, wherein the second bearing surface of the first wedge element and the second bearing surface of the second wedge element lie in substantially parallel planes, wherein urging the first and second wedge elements with respect to one another in a direction to increase wedge assembly thickness applies pressure between the first object surface and the second object surface.

31. The wedge assembly of claim 30, wherein a locking ridge of the first wedge element further comprises:
a rising face lying in a plane intersecting the plane of the first bearing surface in a line between the line of intersection of the first and second bearing surfaces and a line of intersection of a plane orthogonal to the first bearing plane and substantially parallel to the line of intersection of the first and second bearing surfaces, wherein a slope of the rising face is sufficiently shallow to permit advancing of the first wedge along the second wedge without damage to the wedges; and
a falling face lying in a plane intersecting the plane of the first bearing surface in a line distal to the line of intersection of the first and second bearing surfaces with respect to the line of intersection of the rising face and the first bearing surface, wherein a line of intersection of the rising face and the falling face is generally parallel to the other lines of intersection, wherein a slope of the falling face is roughly orthogonal to and more nearly perpendicular to the first bearing surface than the slope of the rising face.

32. The wedge assembly of claim 30, further comprising at least one alignment guide set, wherein an alignment guide in the set is one of an oblong fitting of generally uniform profile fitted at least in part into and free to slide within a recess in each of the interlocking surfaces of two wedges, an oblong recess within a wedge, and an oblong raised fitting integral with a wedge, fitted to and free to slide within an oblong recess within a mating wedge, and wherein a pair of interlocking wedge surfaces are aligned with respect to each other using mating alignment guides.
